(19) United States
(12) Patent Application Publication
(10) Pub. No.: US 2014/0061225 A1
(43) Pub. Date: Mar. 6, 2014

(54) VENDING MACHINE WITH REDUCED NUMBER OF DRIVING MOTORS

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: YUN-LUNG CHEN, New Taipei (TW); ZHI-JUN FU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/866,003

(22) Filed: Apr. 18, 2013

(30) Foreign Application Priority Data
Sep. 6, 2012 (CN) 201210325645.3

(51) Int. Cl. G07F 11/24

(52) U.S. Cl. CPC G07F 11/24
USPC 221/277

(57) ABSTRACT

A vending machine includes a frame and a dispensing assembly. The frame includes a first rigid coil and a second rigid coil which rotate to dispense goods. The dispensing assembly includes a dispensing, a first mounting member, and a second mounting member. Each of the first and second mounting members is rotatably secured to the frame and each supports a rigid coil of opposite helical twist. The dispensing member can rotate clockwise and anticlockwise. When the dispensing member is rotated clockwise, a pawl and ratchet arrangement on the first mounting member engages to rotate dispensing the first rigid coil, whilst an opposing pawl and ratchet arrangement on the second mounting member simply rides over the teeth of the second mounting member and causes no rotation. When the dispensing member is rotated anticlockwise, the roles are reversed dispensing.

### BACKGROUND

1. Technical Field

The present disclosure relates to vending machines, and particularly to a vending machine with reduced number of driving motors.

2. Description of Related Art

In many vending machines, the dispensing assembly includes rigid coils and motors. The motor rotates the coil causing products to be pushed along a channel to eventually drop into a bin accessible by a customer. Generally, each vending machine includes more than 6 partitions, each frame includes more than 8 channels, and each channel secures one dispensing assembly. Thus, more than 48 motors are used in one vending machine, which increase costs of the vending machine and causes more complexity in the assembly process of the dispensing assembly. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a vending machine.

FIG. 2 is similar to FIG. 1, but viewed from a different aspect.

FIG. 3 is an isometric view of a first mounting member of the vending machine of FIG. 1.

FIG. 4 is a partially assembled of a dispensing assembly of the vending machine of FIG. 1, but without a mounting case.

FIG. 5 is an assembled, isometric view of the vending machine of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

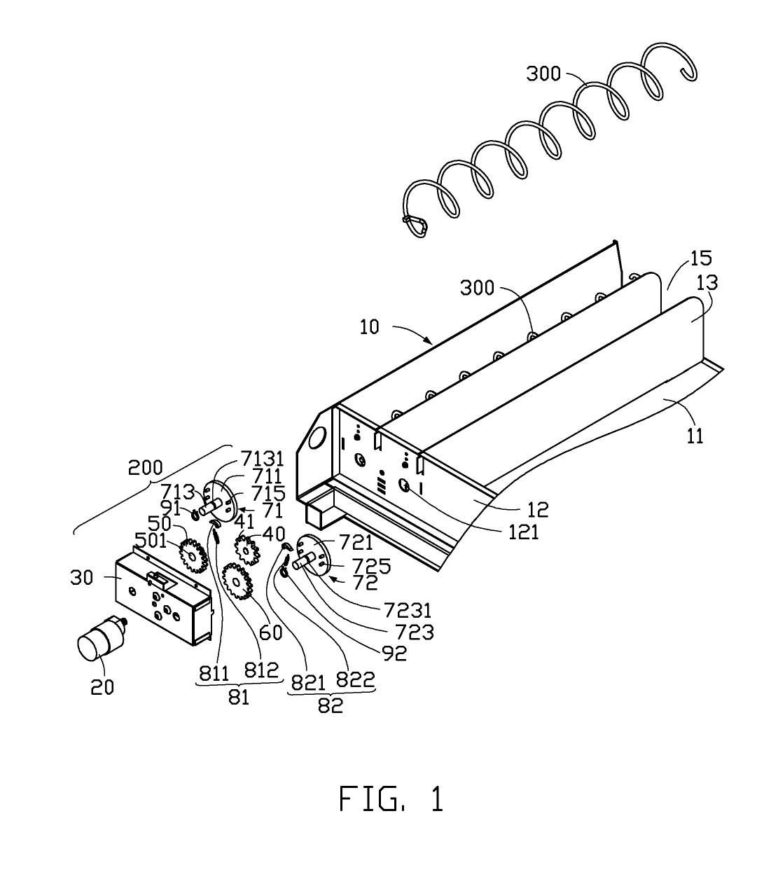

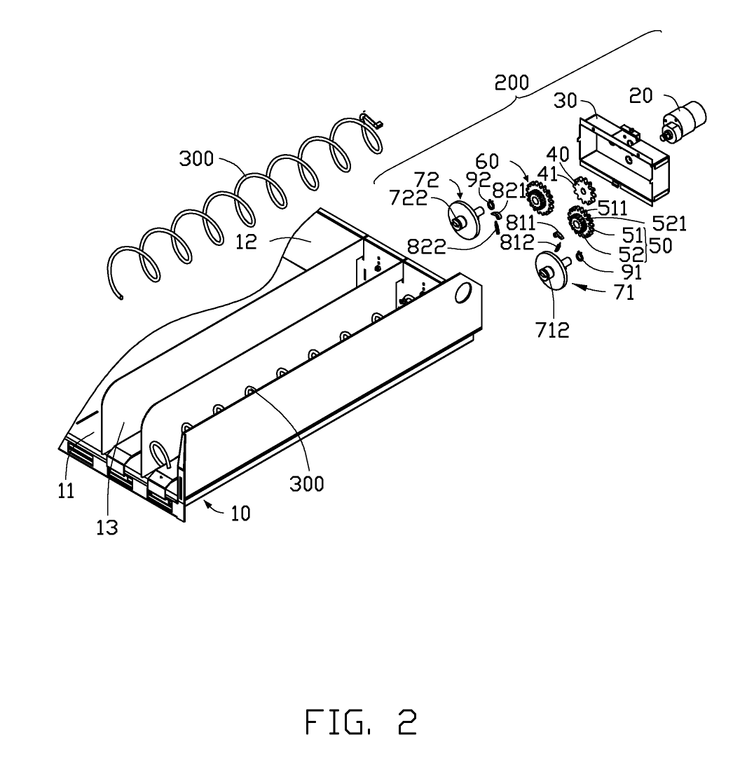

FIG. 1 and FIG. 2 show one embodiment of a vending machine. The vending machine includes a frame 10, a dispensing assembly 200, and a plurality of rigid coils 300 (only two of the plurality of rigid coils 300 shown in FIGS. 1, 2, and 5).

The frame 10 includes a bottom plate 11, a mounting plate 12, and a plurality of dividing plates 13 secured to the bottom plate 11. In one embodiment, the plurality of dividing plates 13 are secured to each other and substantially perpendicular to the mounting plate 12 and the bottom plate 11, and the bottom plate 11 is substantially perpendicular to the mounting plate 12. A goods channel 15 is defined between every two dividing plates 13. The mounting plate 12 defines a plurality of through holes 121 each corresponding to the goods channel 15.

The dispensing assembly 200 includes a dispensing member 20, a mounting case 30, a driving gear 40, a first driven gear 50, a second driven gear 60, a first mounting member 71, a second mounting member 72, a first blocking module 81, and a second blocking module 82.

The dispensing member 20 can rotate the driving gear 40 in either direction. In one embodiment, the dispensing member 20 is a motor.

The mounting case 30 is used for receiving the driving gear 40, the first driven gear 50, the second driven gear 60, the first mounting member 71, the second mounting member 72, the first blocking module 81, and the second blocking module 82. The dispensing member 20 can be secured to the mounting case 30.

The driving gear 40 defines a plurality of straight teeth 41.

The first driven gear 50 defines a first receiving hole 501 and a first straight portion 51 and a first ratchet portion 52 secured to the first straight portion 51. The first straight portion 51 defines a plurality of first straight teeth 511. The first ratchet portion 52 defines a plurality of first ratchet teeth 521. Each of the plurality of first ratchet teeth 521 is oblique relative to each of the plurality of straight teeth 511.

The second driven gear 60 defines a second receiving hole 601 and a second straight portion 61 and a second ratchet portion 62 secured to the second straight portion 61. The second straight portion 61 defines a plurality of second straight teeth 611. The second ratchet portion 62 defines a plurality of second ratchet teeth 621. Each of the plurality of second ratchet teeth 621 is oblique relative to each of the plurality of straight teeth 611.

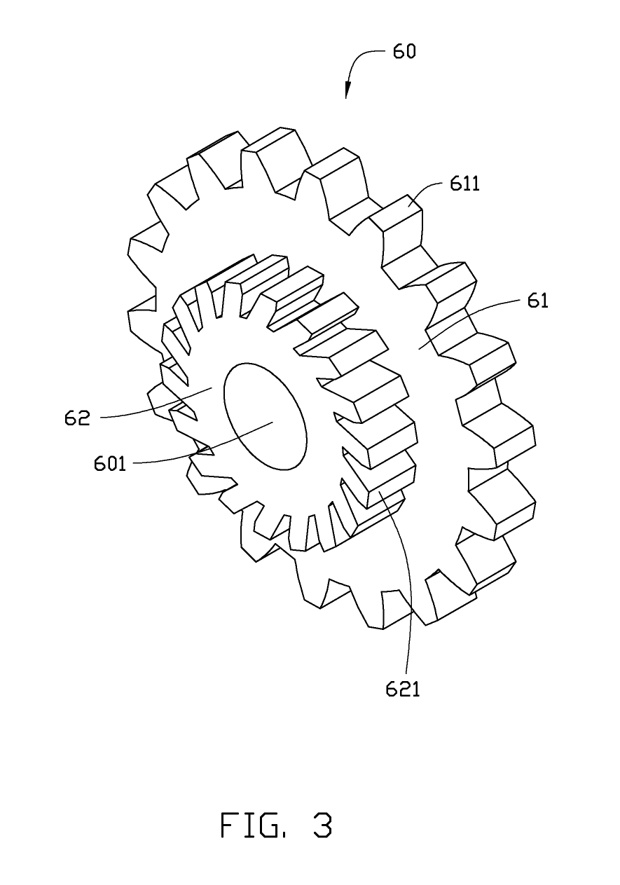

Referring to FIGS. 1-3, the first mounting member 71 includes a first mounting tray 711, a first mounting portion 712 secured to a first side of the first mounting tray 711, and a first installation post 713 secured to a second side of the first mounting tray 711. The first installation post 713 defines a first ring slot 7131. Two first mounting posts 715 extend from the second side of the first mounting tray 711.

The second mounting member 72 includes a second mounting tray 721, a second mounting portion 722 secured to a second side of the second mounting tray 721, and a second installation post 723 secured to a second side of the second mounting tray 721. The second installation post 723 defines a second ring slot 7231. Two second mounting posts 725 extend from the second side of the second mounting tray 721.

The first blocking assembly 81 includes a first blocking member 811 and a first resilient member 812. The first blocking member 811 defines a first mounting hole 8112 and includes a first blocking portion 8113. In one embodiment, the first blocking member 811 is a pawl substantially in the shape of a comma, the first blocking portion 8113 is curved, and the first resilient member 812 is an extension spring.

The second blocking assembly 82 includes a second blocking member 821 and a second resilient member 822. The second blocking member 821 defines a second mounting hole 8212 and includes a second blocking portion 8213. In one embodiment, the second blocking member 821 is also a pawl, the second blocking portion 8213 is curved, and the second resilient member 822 is an extension spring.

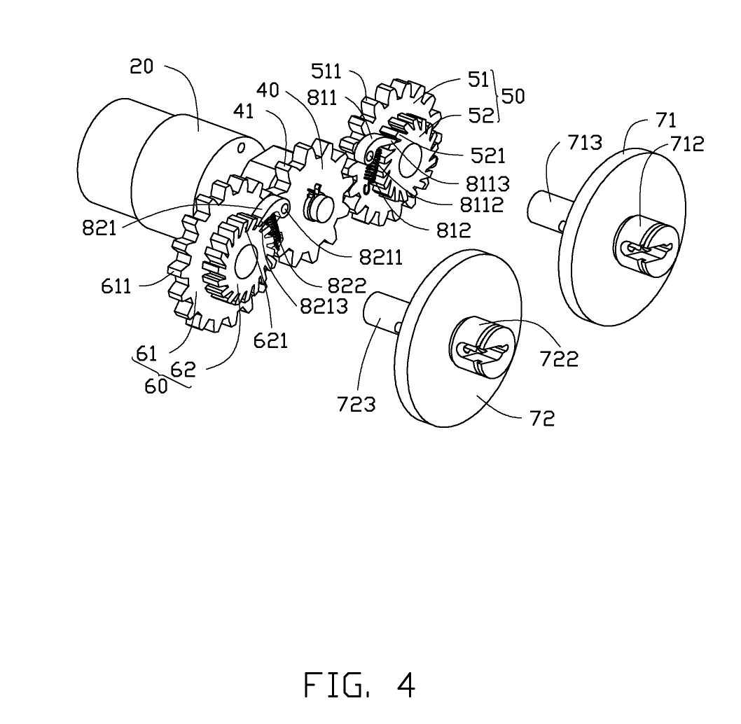

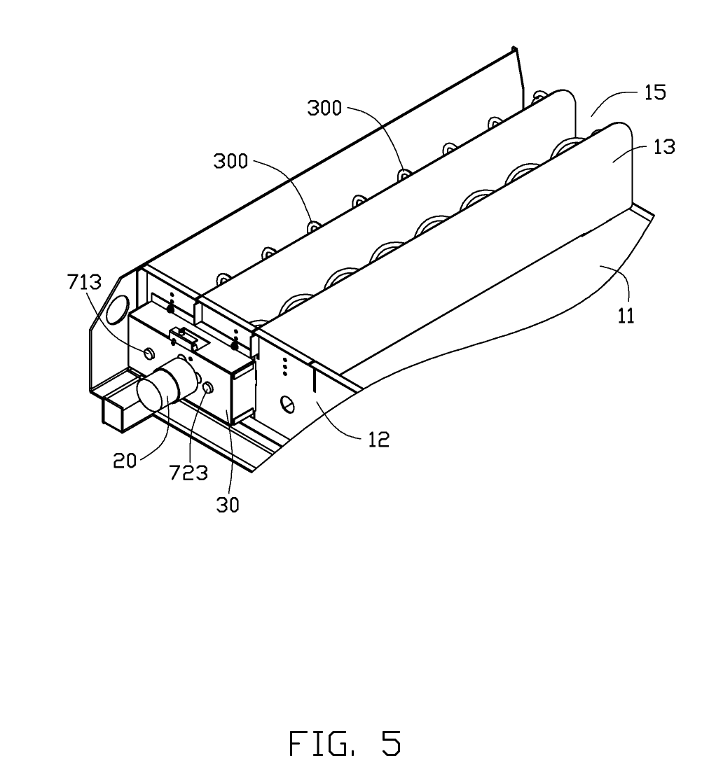

FIG. 4 and FIG. 5 show that, in assembly, the dispensing member 20 is secured to the driving gear 40 through the mounting case 30. One of the two first mounting posts 715 is rotatably received in the first mounting hole 8112, and the first blocking member 811 is rotatably mounted to the first mounting member 71. A first end of the first resilient member 812 is secured to the other one of the two first mounting posts 715, and a second end of the first resilient member 812 is secured to the first blocking member 811. One of the two second mounting posts 725 is rotatably received in the second mounting hole 8212, and the second blocking member 821 is rotatably mounted to the second mounting member 72. A second end of the second resilient member 822 is secured to the other one of the two second mounting posts 725, and a second end of the second resilient member 822 is secured to the second blocking member 821. The first installation post 713 is secured to the mounting case 30 through the first receiving hole 501. A washer 91 is engaged in the first ring slot 7131 to prevent the first driven gear 50 from sliding along the first installation post 713. The second installation post 723 is secured to the mounting case 30 through the second receiving hole 601. A washer 92 is engaged in the second ring slot 7231 to prevent the second driven gear 60 from sliding along the second installation post 723.

In this position, the first driven gear 50 is meshed with a first side of the driving gear 40, and the second driven gear 60 is meshed with the diametrically opposite other side of the driving gear 40. Central axes of the first driven gear 50, the second driven gear 60, and the driving gear 40 are located in one straight line. The first ratchet teeth 521 and the second ratchet teeth 621 extend obliquely opposite to each other. The first blocking portion 8113 is located between adjacent two first ratchet teeth 521. The second blocking portion 8213 is located between adjacent two second ratchet teeth 621.

The dispensing assembly 200 is placed adjacent to the mounting plate 12, and each of the first mounting portion 712 and the second mounting portion 722 is aligned with the through hole 121. The dispensing assembly 200 is moved towards the mounting plate 12, and the each of the first mounting portion 712 and the second mounting portion 722 is inserted through the through hole 121. The mounting case 30 is secured to the mounting plate 12. One rigid coil 300 is secured to the first mounting portion 712, and another rigid coil 300 with an opposite helical twist is secured to the second mounting portion 722.

In use, when the dispensing member 20 is rotated in an anticlockwise direction, the driving gear 40 rotates in the anticlockwise direction. The driving gear 40 drives the first driven gear 50 and the second driven gear 60 to rotate in a clockwise direction. In this position, the first ratchet teeth 521 push the first blocking member 811 and elastically deform the first resilient member 812. When the first blocking member 811 is lifted by a first ratchet tooth 521, the first resilient member 812 rebounds to engage the first blocking member 811 between that first ratchet tooth 521 and a following first ratchet tooth 521. Thus, when the first driven gear 50 is rotated in the clockwise direction, the first blocking member 811 is not able to rotate the first mounting member 71, and the rigid coil 300 secured to the first mounting member 71 is unmoving. When the second driven gear 60 is rotated in the clockwise direction, the second blocking member 821 engages between adjacent second ratchet teeth 621 and is then rotated. In this position, the second driven gear 60 rotates the second mounting member 72 clockwise by means of the second blocking member 821, and the rigid coil 300 secured to the second mounting member 72 is rotated to push goods out of the goods channel 15.

When the dispensing member 20 is rotated in the clockwise direction, the driving gear 40 is rotated clockwise. The driving gear 40 drives the first driven gear 50 and the second driven gear 60 to rotate anticlockwise. In this position, a second ratchet tooth 621 lifts the second blocking member 821 to elastically deform the second resilient member 822. When the second blocking member 821 is between that second ratchet tooth 621 and the following second ratchet tooth 821, the second resilient member 822 rebounds to being between those adjacent two second ratchet teeth 621, but is again lifted by the next second ratchet tooth 821. Thus, when the first driven gear 50 is rotated anticlockwise, the second blocking member 821 is not able to rotate the second mounting member 72, and the rigid coil 300 secured to the second mounting member 72 is unmoving. When the second driven gear 60 is rotated anticlockwise, the first blocking member 811 engages between two adjacent first ratchet teeth 611 and is then rotated together with the first blocking member 811. In this position, the first driven gear 50 rotates the first mounting member 71 anticlockwise by means of the first blocking member 811, and the rigid coil 300 secured to the first mounting member 71 is accordingly rotated anticlockwise to push goods out of the goods channel 15.

The dispensing member 20 is capable of rotating the rigid coils 300 of two separate goods channels 15. The number of the dispensing members 20 which are required is decreased and the assembly process of the dispensing assembly 200 is simpler and more convenient.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A vending machine, comprising:
a frame defining a first goods channel and a second goods channel, and comprising a first rigid coil secured to the first goods channel and a second rigid coil secured to the second goods channel; and
a dispensing assembly comprising a dispensing member, a first mounting member, and a second mounting member, wherein each of the first mounting member and the second mounting member is rotatably secured to the frame; the first rigid coil is secured to the first mounting member; the second rigid coil is secured to the second mounting member; the dispensing member is rotatable towards a first direction and a second direction opposite to the first direction; when the dispensing member is rotated towards the first direction, the dispensing member rotates the first mounting member and the first rigid coil to push goods in the first goods channel; when the dispensing member is rotated towards the second direction, the dispensing member rotates the second mounting member and the second rigid coil to push goods in the second goods channel.

2. The vending machine of claim 1, wherein the dispensing assembly further comprises a driving gear, a first driven gear, and a second driven gear, the driving gear is secured to the dispensing member, and the driving gear is meshed with the first driven gear and the second driven gear.

3. The vending machine of claim 2, wherein the first driven gear and the second driven gear are located on opposite sides of the driving gear, and central axes of the first driven gear, the second driven gear, and the driving gear are located in a straight line.

4. The vending machine of claim 2, wherein the first driven gear comprises a first straight portion and a first ratchet portion located on a first side of the first straight portion; the second driven gear comprises a second straight portion and a second ratchet portion located on a first side of the second straight portion; each of the first straight portion and the second straight portion is meshed with the driving gear; the first ratchet portion defines a plurality of first ratchet teeth; the second ratchet portion defines a plurality of second ratchet teeth; the first ratchet teeth and the second ratchet teeth obliquely extend towards each other relative to the driving gear.

5. The vending machine of claim 4, wherein the dispensing assembly further comprises a first blocking module secured to the first mounting member and a second blocking module secured to the second mounting member; the first driven gear is rotatable to rotate the first mounting member through the first blocking module, and the second driven gear is rotatable to rotate the second mounting member through the second blocking module; and the first blocking module is movably engaged between two adjacent two first ratchet teeth, and the second blocking module is moveably engaged between two adjacent second ratchet teeth.

6. The vending machine of claim 5, wherein when the dispensing member is rotated towards the second direction, the driving gear rotates the first driven gear and the second driven gear towards the first direction, the second blocking module is disengaged from the second ratchet teeth, and the first blocking module is secured between the adjacent two of the plurality of first ratchet teeth and rotates the first mounting member towards the first direction with the first driven gear.

7. The vending machine of claim 5, wherein when the dispensing member is rotated towards the first direction, the driving gear rotates the first driven gear and the second driven gear towards the second direction, the first blocking module is disengaged from the first ratchet teeth, and the second blocking module is secured between the two adjacent second ratchet teeth and rotates the second mounting member towards the second direction with the second driven gear.

8. The vending machine of claim 7, wherein when the dispensing member is rotated towards the second direction, the driving gear rotates the first driven gear and the second driven gear towards the first direction, the second blocking module is disengaged from the second ratchet teeth, and the first blocking module is secured between the adjacent two of the plurality of first ratchet teeth and rotates the first mounting member towards the first direction with the first driven gear.

9. The vending machine of claim 5, wherein the first blocking module comprises a first blocking member and a first resilient member; the first blocking member comprises a curved first blocking portion, and the curved first blocking portion disengages from the first ratchet teeth when the first driven gear is rotated towards the second direction, the first blocking member is rotatably mounted to the first straight portion; the second blocking module comprises a second blocking member and a second resilient member, the second blocking member comprises a curved second blocking portion, and the curved second blocking portion disengages from the second ratchet teeth when the second driven gear is rotated towards the first direction.

10. The vending machine of claim 9, wherein the first resilient member is secured between the first mounting member and the first blocking member, and the second resilient member is secured between the second mounting member and the second blocking member.

11. The vending machine of claim 5, wherein the dispensing assembly further comprises a mounting case, and the dispensing member is rotatably mounted to the mounting case; and the driving gear, the first driven gear, the second driven gear, the first blocking module, and the second blocking module are received in the mounting case.

12. A vending machine, comprising:
a frame defining a first goods channel and a second goods channel, and comprising a first rigid coil secured to the first goods channel and a second rigid coil secured to the second goods channel; and
a dispensing assembly comprising a dispensing member, a first mounting member, a second mounting member, a driving gear secured to the dispensing member, a first driven gear meshed with the driving gear, a second driven gear meshed with the driving gear, a first blocking module movably mounted to the first mounting member, and a second blocking module movably mounted to the second mounting member, wherein each of the first mounting member and the second mounting member is rotatably secured to the frame; the first rigid coil is secured to the first mounting member; the second rigid coil is secured to the second mounting member; the dispensing member is rotatable towards a first direction and a second direction opposite to the first direction; when the dispensing member is rotated towards the first direction, the dispensing member rotates the driving gear towards the first direction, the driving gear rotates the first driven gear and the second driven gear towards the second direction, the first blocking member is disengaged from the first driven gear, and the second blocking member is engaged with the second driven gear and secures the second mounting member to the second driven gear; and when the dispensing member is rotated towards the second direction, the driving gear rotates the first driven gear and the second driven gear towards the first direction, the first blocking member is engaged with the first driven gear and secures the first mounting member to the first driven gear, and the second blocking member is disengaged from the second driven gear.

13. The vending machine of claim 12, wherein the first blocking module comprises a first blocking member, and the first blocking member comprises a first mounting portion and a first blocking portion; the first mounting portion is rotatably mounted to the first mounting member, and the first blocking portion is movably mounted to the first driven gear; the second blocking module comprises a second blocking member, and the second blocking member comprises a second mounting portion and a second blocking portion; the second mounting portion is rotatably mounted to the second mounting member, and the second blocking portion is movably mounted to the second driven gear.

14. The vending machine of claim 12, wherein the first driven gear and the second driven gear are located on opposite sides of the driving gear, and central axes of the first driven gear, the second driven gear, and the driving gear are located in a straight line.

15. The vending machine of claim 13, wherein the first driven gear comprises a first straight portion and a first ratchet portion located on a first side of the first straight portion; the second driven gear comprises a second straight portion and a second ratchet portion located on a first side of the second straight portion; each of the first straight portion and the second straight portion is meshed with the driving gear; the first ratchet portion defines a plurality of first ratchet teeth; the second ratchet portion defines a plurality of second ratchet teeth; the first ratchet teeth and the second ratchet teeth obliquely extend towards each other relative to the driving gear.

16. The vending machine of claim 15, wherein the first blocking module is movably engaged between two adjacent first ratchet teeth, and the second blocking module is movably engaged between two adjacent second ratchet teeth.

17. The vending machine of claim 15, wherein the first blocking module further comprises a first resilient member; the first blocking member comprises a curved first blocking portion, and the curved first blocking portion disengages from the first ratchet teeth when the first driven gear is rotated towards the second direction, and the first blocking member is rotatably mounted to the first straight portion; the second blocking module comprises a second blocking member and a second resilient member, the second blocking member comprises a curved second blocking portion, and the curved second blocking portion disengages from the second ratchet teeth when the second driven gear is rotated towards the first direction.

18. The vending machine of claim 17, wherein the first resilient member is secured between the first mounting member and the first blocking member, and the second resilient member is secured between the second mounting member and the second blocking member.

19. The vending machine of claim 12, wherein the dispensing assembly further comprises a mounting case, and the dispensing member is rotatably mounted to the mounting case; and the driving gear, the first driven gear, the second driven gear, the first blocking module, and the second blocking module are received in the mounting case.
